(19) United States
(12) Patent Application Publication
(10) Pub. No.: US 2026/0187287 A1
(43) Pub. Date: Jul. 2, 2026

(54) CONTEXT-AWARE AND CONTEXT-PERSERVING SECURITY ENGINE FOR GENERATIVE ARTIFICIAL INTELLIGENCE MODELS

(71) Applicant: Perpetual Intelligence Inc., Calgary (CA)

(72) Inventors: Mohan J. Kumar, Battleground, WA (US); David King, Calgary (CA); Michael Curry, Harley (CA)

(21) Appl. No.: 19/431,678

(22) Filed: Dec. 23, 2025

Related U.S. Application Data
(60) Provisional application No. 63/739,212, filed on Dec. 27, 2024.

(51) Int. Cl. G06F 21/64; G06N 20/00

(52) U.S. Cl. CPC G06F 21/64; G06N 20/00

(57) ABSTRACT

Disclosed examples generally relate to a security engine for generative artificial intelligence (GenAI) models, and methods for operating thereof. In some examples, there is provided a method for operating a security engine in association with a generative artificial intelligence (GenAI) model, comprising: analyzing an input prompt based on one or more predefined security input policies; generating a secured input prompt, corresponding to the input prompt; transmitting the secured input prompt to the GenAI model; receiving an original output response from the GenAI model; analyzing the original output response based on one or more predefined security output policies; generating a secured output response, based on the original output response; and outputting the secured output response on a user device.

### CROSS-REFERENCE TO RELATED APPLICATION(S)

This application claims the benefit of, and priority to, U.S. Provisional Patent Application No. 63/739,212, filed on Dec. 27, 2024, the entirety contents of which are hereby incorporated by reference.

### FIELD

Disclosed examples generally relate to generative artificial intelligence (GenAI) models, and in particular, to a context-aware and context-preserving security engine for GenAI models, and methods for operating thereof. In some examples, the disclosed security engine operates as a secure firewall layer for GenAI models.

### BACKGROUND

Generative AI (GenAI) models have come to prominence in recent years due to their ability to create original artifacts in response to input prompts comprising text, images, audio or videos. A well-known example of a class of GenAI models are large language models (LLMs). Some common examples of LLMs include OpenAI™ ChatGPT™, Google™ Gemini™ and Microsoft™ CoPilot™.

To this end, GenAI models are often trained on a very large dataset. While this makes the models very powerful, it also exposes the models to sensitive data included in the training dataset. In turn, privacy and data confidentiality challenges are encountered, as use of GenAI models can inadvertently expose sensitive personal information (PI) through data processing and/or model outputs.

GenAI systems also all lack many control features. This includes lacking any means to control or enforce country or state specific laws, ethical considerations, geographic awareness specific response, to name a few.

Accordingly, while all walks of life (e.g., arts, entertainment, legal, software coding) scramble to adopt GenAI models, their adoption is gated by critical challenges relating to privacy, data confidentiality and lack of input/output control.

### SUMMARY

Disclosed examples provide for a security engine configured to protect an AI ecosystem, from cloud to edge. The security engine may be configured as an AI firewall, specifically targeted to generative AI (GenAI) models. The security engine can support the entire gamut of GenAI models, from large language models that run in cloud enterprises to smaller models that run on edge devices.

In at least one example, the security engine provides bidirectional inspection of inputs and outputs to and from a GenAI model. In this manner, the engine acts as a safeguard shield, screening both incoming and outgoing data for web exploits, personally identifiable information (PII) exposure, and ethical concerns.

As provided herein, the security engine can use quantum-resistant encryption, and genetic algorithm evolution to stay ahead of emerging threats. With features like multimodal AI protection, real-time model behavior analysis, and ethical AI compliance checking, the security engine safeguards not just the data but also the organization.

In at least one broad aspect, there is provided a method for operating a security engine in association with a generative artificial intelligence (GenAI) model, comprising at least one of: operating an input prompt analysis system configured for: analyzing an original input prompt based on at least one predefined input security policy; generating a secured input prompt, corresponding to the original input prompt; and transmitting the secured input prompt to the GenAI model; and operating an output response analysis system configured for: receiving an original output response from the GenAI model; analyzing the original output response based on at least one predefined output security policy; generating a secured output response, based on the original output response; and outputting the secured output response.

In another broad aspect, there is provided a system for operating a security engine in association with a generative artificial intelligence (GenAI) model, comprising: at least one processor; and at least one memory storing computer-executable instructions, which when executed by the at least one processor, configure it to perform the method comprising at least one of: operating an input prompt analysis system configured for: analyzing an original input prompt based on at least one predefined input security policy; generating a secured input prompt, corresponding to the original input prompt; and transmitting the secured input prompt to the GenAI model; and operating an output response analysis system configured for: receiving an original output response from the GenAI model; analyzing the original output response based on at least one predefined output security policy; generating a secured output response, based on the original output response; and outputting the secured output response on a user device.

In some examples, input prompt comprises one or more of: (i) a blocked input prompt, (ii) the original input prompt, and (iii) a modified input prompt.

In some examples, analyzing the input prompt based on the at least one predefined input security policy, comprises: identifying contextual data associated with the input prompt; identifying at least one policy non-compliance signature, associated with the input security policies; analyzing one or more of the (i) input prompt, and (ii) contextual data, to determine the presence of the at least one policy non-compliance signature; and in response to determining the presence of the signature, generating the secured input prompt comprising the blocked input prompt or the modified input prompt, otherwise, generating the secured input prompt as comprising the original input response.

In some examples, the input prompt is multimodal, and the method further comprises determining one or more derivative features of the input prompt using a multimodal conversion module and/or a content screening module, and further analyzing the input security policies in view of the derivative features.

In some examples, the method further comprising generating a user profile summary based on contextual user-specific data, and transmitting the user profile summary as the auxiliary input data to the GenAI model.

In some examples, the output response comprises one or more of: (i) a blocked output response, (ii) the original output response, and (iii) a modified output response.

In some examples, analyzing the output response based on the at least one predefined output security policy, comprises: identifying contextual data associated with the output response; identifying at least one policy non-compliance signature, associated with the output security policies; analyzing one or more of the (i) output response, and (ii) contextual data, to determine the presence of the at least one policy non-compliance signature; and in response to determining the presence of the signature, generating the secured output prompt comprising the blocked output response or the modified output response, otherwise, generating the secured output response as comprising the original output response.

In some examples, output response is multimodal, and the method further comprises determining one or more derivative features of the output response using a multimodal conversion module and/or a content screening module, and further analyzing the input security policies in view of the derivative features.

In some examples, the security engine includes one or more of: (i) at least one trained rule-specific model associated with enforcing an input or output security policy, and (ii) a trained security machine learning model for identifying one or more features relating to a security threat.

In some examples, the security engine is deployed in association with one or more GenAI models, and the security policies are configurable for each GenAI model.

In different embodiments, the present invention may comprise a method or system comprising any combination of elements or features described herein, or which specifically omits any particular feature or element described herein.

### BRIEF DESCRIPTION OF THE DRAWINGS

In the drawings, like elements may be assigned like reference numerals. The drawings are not necessarily to scale, with the emphasis instead placed upon the principles of the present disclosure. Additionally, each of the embodiments depicted are but one of a number of possible arrangements utilizing the fundamental concepts of the present disclosure.

FIG. 1 is an example networked computing environment for deploying generative AI (GenAI) models.

FIG. 2A is simplified block diagram of a security engine deployed in association with a GenAI model.

FIG. 2B shows an example configuration for a security engine.

FIG. 2C shows an example configuration for a multimodal conversion module and a content screening module.

FIG. 2D shows a data flow diagram between various modules of the security engine.

FIG. 3A is a simplified block diagram exemplifying use of a security engine incorporating a trained machine learning model.

FIG. 3B is a simplified block diagram exemplifying use of a security engine incorporating the trained model, and further including a learning engine.

FIG. 3C is a simplified block diagram exemplifying use of a security engine with a media generator module.

FIG. 4A is a process flow for an example method for using a security engine in association with a GenAI model.

FIG. 4B is a process flow for an example method for operating a security engine to generate secured input prompts.

FIG. 4C is a process flow for an example method for operating a security engine to generate secured output responses.

FIG. 4D is a process flow for a method for training and re-training a learned security machine learning model.

FIG. 5 is an example graphical user interface (GUI) associated with disclosed examples.

FIG. 6 is a simplified example hardware block diagram for a server.

### DETAILED DESCRIPTION

Disclosed examples generally relate to a security engine for GenAI models, and methods for operating thereof.

### I. DEFINITIONS

Any term or expression not expressly defined herein shall have its commonly accepted definition understood by a person skilled in the art. As used herein, the following terms have the following meanings.
“Context-awareness” refers to a capability of a security engine to evaluate and apply contextual data when making determinations or taking actions in connection with input and output transactions involving a GenAI model.
“Context-preserving” refers to the capability of a security engine to retain (e.g., store in memory or databases) and propagate relevant contextual data across transactions with GenAI models so that decisions and outputs remain consistent with the established context.
“Contextual data” refers to data that characterizes the context in which an input or output transaction occurs with a GenAI model. It may be provided to, or used in association with, the GenAI model to influence how outputs are generated from the GenAI model, such as to produce context-specific or user-specific outputs. In some examples, contextual data is also used to inform enforcement of one or more policies. Such data may include, by way of example, user-specific data (as discussed further below) and memory threat cache data.
“Derivative features” refer to attributes derived from preprocessing or screening an input prompt or an output response. As provided herein, the attributes may represent normalized, transformed, or summarized content usable for policy evaluation.
“Engine” refers to a logical grouping of software instructions and/or associated data structures that, when executed by one or more processors, cause performance of a defined function, including managing data flow and/or control operations.
“Generative AI (GenAI) systems” or “GenAI models” refer to artificial intelligence systems and/or models capable of generating new content, such as text, images, audio, or video, based on patterns learned from training data. These systems include, but are not limited to, large language models (LLMs) that generate human-like text by predicting subsequent tokens (i.e., small units of text like works or characters) in a sequence. Unlike traditional machine learning (ML) models, which primarily perform tasks such as classification, prediction, or optimization based on existing input-output mappings, generative AI systems are distinct in their ability to autonomously synthesize novel outputs that resemble human-created content. GenAI models work by detecting the pattern and context of the request and generating new data that resembles the patterns it learned from its training data. In some examples, GenAI models utilize transformers, a neural network architecture designed for handling sequential data efficiently and enabling context-aware outputs. In use, a GenAI model receives an input prompt. As used herein, an “input prompt” is an instruction, query, or context that guides the GenAI model in generating a specific output response. The input prompt or output response may comprise text, audio, images or video or the like.
“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.
“Module” or “submodule” refers to a logical software component that performs a defined sub-function within an engine and provides structured outputs to one or more other software components.
“Policy non-compliance signatures” refer to detectable artifacts indicating that a prompt or response fails, in whole or in part, to meet a specific security policy rule.
“Preset” or “predefined” value means a predefined reference stored in a component's memory.
“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), field programmable gate arrays (FPGAs), and digital signal processors.
“Real time or near real time” means actions or processes performed either instantaneously after receiving specific inputs, or within a very short timeframe, typically measured in seconds (e.g., within 0.0001 to 5 seconds).
“Security policies” are formal, machine-executable (e.g., computer-executable) rules, guidelines, guardrails and/or procedures which are designed to govern and control the data flow to and/or from GenAI models. More broadly, security policies enable actions such as blocking (in-part or in whole), modifying, or permitting data flow in and out of GenAI models. In some examples, they are implemented to enforce confidentiality and access control, as well as protecting GenAI models from security threats.
“Transaction” is an input or output interaction with a GenAI model, comprising the submission of a prompt or the delivery of a response, together with its associated contextual data and policy evaluation.

### II. GENERAL OVERVIEW

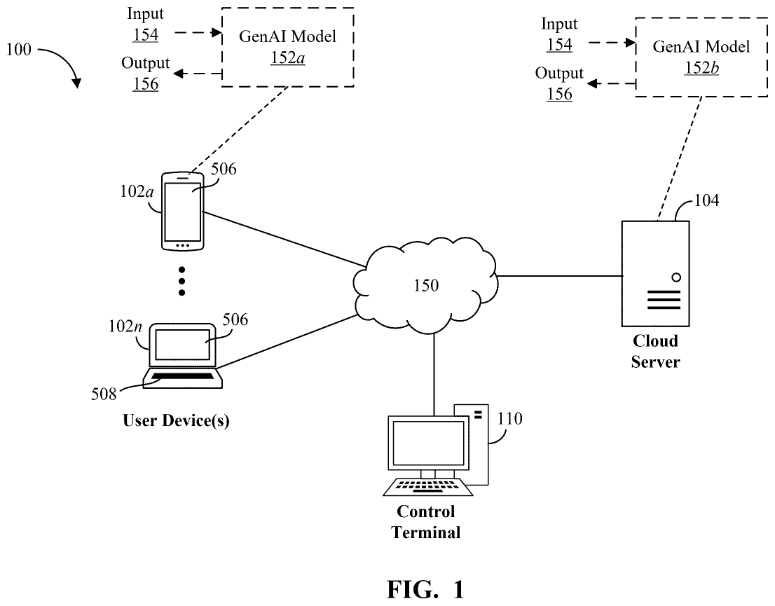

FIG. 1 shows an example computing environment 100 for deploying generative AI (GenAI) models. Environment 100 also exemplifies a networked computing environment for deploying the disclosed security engine(s).

As shown, the environment 100 can include one or more user devices 102a-102n. User devices 102 comprise any suitable computing devices, including smartphones, personal computers, or tablets.

User devices 102a-102n can couple to a server 104 via a communication network 150. Communication network 150 is a wired and/or wireless network and may include an internet connection.

Server 104 can be a cloud server or the like. While only one server 104 is illustrated in FIG. 1, it is understood that the environment 100 can include a plurality of interconnected servers.

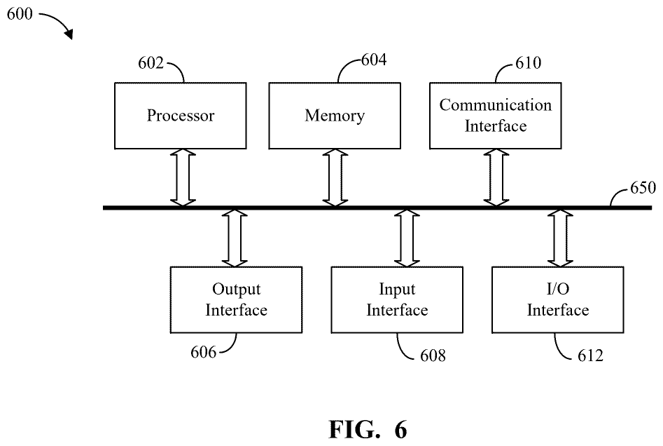

As provided further herein, with reference to FIG. 6, each computing device 102, 104 in the environment 100 can include a processor 602 coupled to a memory 604. The processor 602 may also couple to one or more of an output interface 606, input interface 608, communication interface 610, and input/output (I/O) interface 612.

Continuing with reference to FIG. 1, environment 100 also includes one or more GenAI models 152a, 152b. Each GenAI model 152 is trained to receive input prompts 154, and to generate corresponding output responses 156. Input prompts 154 and output responses 156 may be in any media form, inclusive of text, images, video or audio. As used herein, “media form” refers to the modality of input or output content 154, 156. The media form can be single-modal (e.g., text, image, audio, or video individually) or multimodal (a combined presentation of two or more modalities).

As exemplified, the GenAI model 152 can be hosted: (i) directly on one or more of the user devices 102a-102n, acting as edge devices in the networked environment 100; and/or (ii) on one or more cloud servers 104. For instance, smaller models are deployable on edge computing devices 102a-102n, while larger models are hosted on computer server(s) 104.

Where a GenAI model 152a is hosted directly on a user device 102a-102n, the model 152a may be accessible through a software application downloaded onto the user device 102.

Alternatively, where the GenAI model 152b is remotely hosted on server 104, the model may be accessible from a user device 102 via a web application, through a website, or through API integrations for programmatic access. In these examples, the user device 102 transmits, via network 150, a user input prompt to the GenAI model 152b hosted on the server 104. In return, the server 104 transmits back, via network 150, the output response to the user device 102.

To this effect, despite the widespread proliferation of GenAI models, use of these models suffers from a number of critical challenges:
First, from a user input perspective, GenAI models are unable to filter and control the types of inputs passed into the model. For example, many models cannot prevent users from inputting personally identifiable information (PII) or other sensitive information, such as corporate data. This is particularly important because the GenAI models may train on this sensitive input data, and then inadvertently disclose this data to another third party in an output response.

Additionally, from a model safety perspective, many models cannot filter inputs that pose system vulnerability threats. For example, existing models fail to effectively filter excessive input requests, or malicious inputs designed to disrupt or harm the system.
Second, from a data output perspective, GenAI models are typically poorly configured to control the generated output. For example, existing models lack mechanisms to limit the output based on the user viewing the output, and/or the sensitivity of the information contained in the output. Existing models are also not configurable to control outputs to enforce country- or state-specific laws, adhere to ethical guidelines, or provide geographically aware responses.

In view of the foregoing, there is desire for a fronting policy and enforcement layer that allows deployers of GenAI models to implement bespoke policy, and enforce that policy under all circumstances.

### III. GENAI SECURITY ENGINE

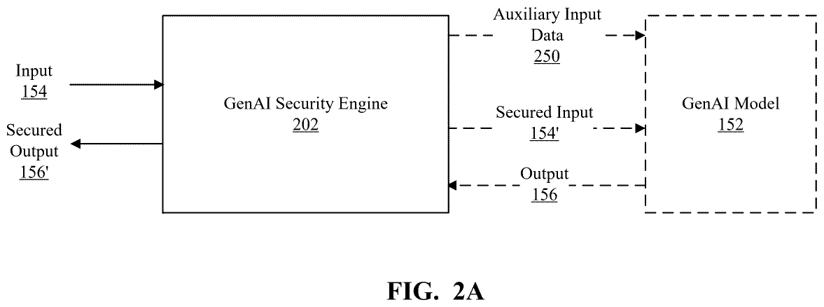

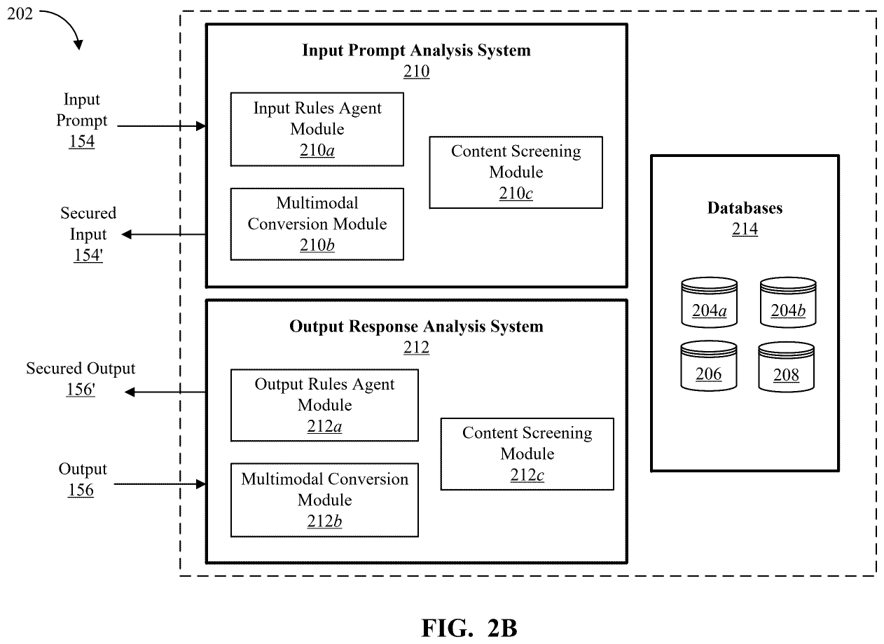

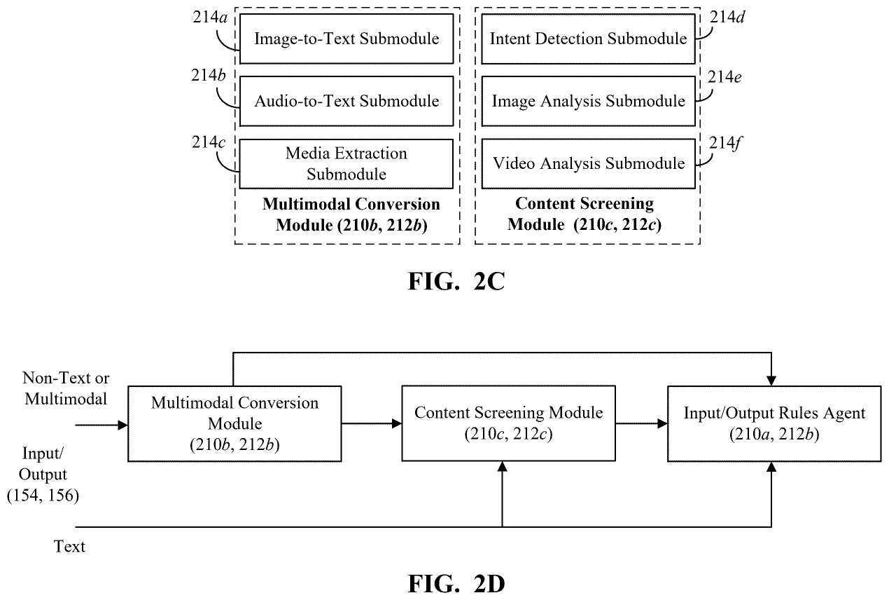

FIG. 2A is simplified block diagram of a security engine 202 deployed in association with a GenAI model 152, in accordance with disclosed examples.

As explained herein, security engine 202 functions as a secure firewall layer for the GenAI model 152. In some examples, the security engine 202 operates as an advanced Web Application Firewall (WAF) that is specifically designed for GenAI applications.

The security engine 202 is hosted on anyone, or one or more, of computing devices 102, 104 in environment 100.

In some examples, the security engine 202 is hosted on the same computing device hosting the GenAI model 152. In other examples, the security engine 202 is hosted on a different computing device from the GenAI model 152. For instance, the security engine 202 is hosted on a first device, while the GenAI model 152 is hosted on a second device. In this case, network 150 is used to relay data between the security engine 202 and the GenAI model 152, hosted on different connected devices.

In more detail, the security engine 202 operates as a secure intermediary layer between, (i) the user inputs and outputs, and (ii) the GenAI model 152.

In at least one example, the security engine 202 includes security policies 204a, 204b. Security policies 204 are used for controlling: (a) input prompts 154 transmittable to the GenAI model 152, from a user device 102, and (b) output responses 156 transmittable from the GenAI model 152, back to a user device 102.

### II. EXAMPLE CONFIGURATION FOR SECURITY ENGINE

FIG. 2B illustrates an example configuration for the security engine 202. As shown, the security engine 202 generally includes: (i) an input prompt analysis system 210, (ii) an output response analysis system 212, and/or (iii) one or more databases 214.

The various components of the security engine 202 may be stored or hosted on a computer device memory, such as a memory of a user device 102 and/or server 104.

As well, in some cases, the input prompt analysis system 210 can be the same as, or partially overlapping with, the output response analysis system 212. For example, the rules agents 210a, 212a used in these systems (as well as other modules described below), may be the same or different. Otherwise, these can be different systems.

### (i.) Databases

As further exemplified in FIG. 2B, the security engine 202 can store databases, including one or more of: (i) a predefined input security policies database 204a, (ii) a predefined output security policies database 204b, (iii) a user configurable policies database 206, and (iv) a user profiles database 208. As disclosed herein, input prompts 154 and output responses 156 may be analyzed in view of the relevant policies and stored database information.

### (a.) Input Security Policies.

Input security policies 204a govern and control the input prompts 154, or portions thereof, that the security engine 202 transmits to the GenAI model 152. These policies can permit/allow, modify, and/or block all (or any portion) of an input prompt into a GenAI model 152.

By way of example, input security policies 204a limit or block input prompts that: (i) pose security threats to the GenAI model 152 (e.g., identifying and mitigating threats before they reach the model), (ii) disclose predefined classes of information, including personally identifiable information (PII) and/or sensitive corporate data, (iii) request information that is inaccessible to a user class (or a user type) making the request, and/or (iv) request information that is inaccessible based on the user's geographic location (e.g., as a result of state or national laws).

In some examples, the stored input policies 204a comprise a set of predefined rules, each rule being associated with one or more predefined policy non-compliance signatures. As used herein, a non-compliance signature refers to a detectable artifact present in an input prompt 154 or in generated derivative features (as defined below) that indicates full or partial violation or non-compliance of a corresponding policy rule.

For example, a rule may prohibit personally identifiable information (PII) from being input into the GenAI model 152. One or more policy non-compliance signatures, associated with the rule, may define detectable categories of PII, such as names, addresses, or identifiers, that are identifiable within an input prompt. Each rule may accordingly be associated with one or more corresponding policy non-compliance signatures.

### (b.) Output Security Policies.

In contrast to input security policies 204a, the output security policies 204b govern and control the types of output responses, or portions thereof, that the security engine 202 transmits back to a user device 102.

Examples of security output policies 204b include, policies that permit, modify, and/or block all (or any portion) of an output response. The output policies may be based, for example, on a user's access privileges and/or geographic location, and may otherwise be similar to the input policies.

In some examples, similar to the input policies, the stored output policies 204b comprise a set of predefined rules, each rule being associated with one or more predefined policy non-compliance signatures. The non-compliance signatures can include detectable artifacts present in an output response 156 or in generated derivative features (as defined below) that indicate full or partial violation or non-compliance of a corresponding policy rule.

### (c.) User Configurable Security Policies.

The security policies 204a, 204b, in security engine 202, may be user configurable. For instance, in FIG. 1, the environment 100 can include a control terminal 110. An operator can use the terminal 110 to modify rules associated with the input and output policies 204a, 204b. The modified policies are then pushed to the security engine 202, which allows the security engine 202 to update its operation based on these new policies. In turn, an organization may dynamically modify its policies to reflect changing security and/or user access requirements.

### (d.) User Profiles.

As shown in FIG. 2, the security engine 202 can store a user profile database 206.

In at least one example, the user profiles 206 store contextual user-specific data, associated with different users of a GenAI model 152. User-specific data comprises one or more of: (i) user credential data, (ii) user prior interaction data with a GenAI model, and (iii) a set of user access privileges.

User credential data can include user identity attributes or authorization attributes (e.g., identifiers such as login IP address or sessional login details).

User prior interaction data can include audit trails that provide a historic log of each user's prior actions with a GenAI model. For instance, a user audit trail can include (i) previous action details (e.g., previous input prompts by that user and received output responses), (ii) timestamps for prior actions, (iii) prior location data of user when engaging the GenAI model 152, and/or (iv) previous security policies the user failed to satisfy with prior input prompts.

In an organizational setting (or otherwise), user profile database 206 can also store “user access privileges”. User access privileges are useful in determining the type or class of information the user can request in an input prompt, or otherwise, can receive in an output response. Based on the user access privileges, the security engine 202 can determine the appropriate input or output security policy to apply to that user, or user class.

In some examples, the user data in the user profile database 206 is encrypted to ensure the data is securely stored therein. The system may, for example, use post quantum cryptography (PQC). It has been appreciated that an advantage of using PQC is to prevent attacks, such as Harvest Now, Decrypt Later (HNDL) attacks, as known in the art.

In some examples, the security engine 202 may be capable of generating a summary of all or some of the user-specific data and transmitting that summary to the GenAI model 152. This summary may be transmitted as part of the secured input prompt 154′, or separately, as auxiliary input data 250. The GenAI model 152 may then use the summary data to generate enhanced contextual responses, tailored to the specific user's history and background.

In at least one example, once the user is identified by the security engine 202 (e.g., based on their IP address or sessional login information)—the security engine 202 can “tag” the input prompt with a user identifier. The tag may be in the form of a metatag, which is appended to the input prompt. The tag is then transmitted to the user profile database 206 to retrieve further relevant user-specific data.

### (e.) Memory Threat Cache.

As still further exemplified in FIG. 2B, the security engine 202 can store a contextual memory threat cache 208. Memory threat cache 208 retains historic data for previously detected security threats.

As referenced herein, a “security threat” includes input prompts 154 that pose a security risk to the GenAI model, including threats that can disrupt GenAI operation, expose sensitive data, or degrade system integrity and/or availability. The memory threat cache 208 allows the security engine 202 to more proactively identify potential security threats that contravene input security policies.

Examples of data stored in the memory threat cache 208 include: (i) timestamp data of a priorly detected threat, (ii) associated user or user identifier (or user credential data) for user that posed the threat, (iii) geographic location where the threat emanated, (iv) threat indicators that identifies malicious activity (e.g., malware file name, server details), and/or (v) threat signatures that comprise a pattern or identifiable attribute of a threat (e.g., IP address, URLs, etc.).

As explained below, the memory threat cache 208 is also used for training a learned security machine learning (ML) model 304. This allows the ML model to more efficiently analyze input prompts to detect threat features and signatures.

### (ii.) Input Prompt Analysis System

Input prompt analysis system 210 is configured to process single and/or multimodal input prompts 154 and to enforce predefined input security policies 204a.

As best shown in FIG. 2B, the input prompt analysis system generally includes: (i) an input rules agent module 210a, and in some cases, (ii) a multimodal conversion module 210b, and (iii) a content screening module 210c.

### (a.) Input Rules Agent Module.

Input rules agent module 210a is configured to apply the predefined input security policies 204a to the input prompt 154, to ensure policy compliance. In making this determination, it may receive or access: (i) the original input prompt 154, and (ii) input security policies 204a, and possibly one or more of contextual data from databases 206, 208 and outputs from one more modules 210b, 210c. The input rules agent module 210a analyzes the accessed data to detect a match with one or more policy non-compliance signatures associated with respective input policy rules (e.g., binary matches or confidence-based matches).

Based on a match outcome, the input rules agent module 210a may then either (i) entirely block the input prompt entirely, or (ii) generate a secured input prompt 154′, that is transmitted to the GenAI model 152.

In examples where the security engine 202 generates a secured input prompt 154′, the secured input prompt 154′ may be identical to the original input 154. This occurs, for instance, if the original input 154 satisfies all of the relevant input security policies 204a. In other examples, the secured input 154′ is a modified version of the original input 154. For example, the security engine 202 modifies the original input 154 to satisfy the security input policies 204a. This can involve blocking a portion of the input prompt to comply with relative policies, such as blocking sensitive data.

As shown in FIG. 2A, it is possible for the security engine 202 (e.g., rules agent) to also generate auxiliary input data 250, which is also passed onto the GenAI model 152. Auxiliary input data 250 broadly includes any data generated separate from the input prompt 154. Examples of auxiliary data include, (i) secondary data generated based on analyzing the content of the input prompt 154 (e.g., derivative features, as explained below), and/or (ii) contextual data (as explained further below).

### (b.) Multimodal Conversion Module.

Multimodal conversion module 210b is configured to receive non-textual or multi-media input prompts. The module performs modality detection and, as applicable, (i) transforms non-text inputs into textual representations, and/or (ii) separates composite multi-media prompts into constituent elements, such as video, image frames, audio, and extracted text.

### (c.) Content Screening Module.

Content screening module 210c is configured to perform pre-rules filtering of input prompts 154 to ensure appropriateness and intent compliance before policy evaluation. The module 210c may operate as a standalone generic filter separate from the rules agent 210a. In other cases, it is integrated fully or partially with the rules agent to apply policies directly. In some cases, it may also be user configurable.

### (iii.) Output Response Analysis System

Output response analysis system 212 is configured to process single and/or multimodal output responses generated by the GenAI model 152, and to enforce predefined output security policies.

As exemplified in FIG. 2B, the output response analysis system 212 may include: (i) an output rules agent module 212a, and in some cases, (ii) a multimodal conversion module 212b, and (iii) a content screening module 212c.

Similar to the input rules agent 210a, the output rules agent module 212a is configured to apply predefined output security policies 204b to the original output response 156 from the GenAI model 152. In making this determination, it may receive or access: (i) the original output response 156 and (ii) output security policies 204b, and possibly one or more of contextual data from databases 206, 208, and outputs from one more modules 212b, 212c.

The output rules agent module 210a then analyzes the accessed data to detect a match with one or more policy non-compliance signatures associated with respective output policy rules, (e.g., binary matches or confidence-based matches).

Based on the matching analysis, as shown in FIG. 2A, the output rules agent 212a may either (i) block the output response entirely, or (ii) generate a secured output response 156′, that is transmitted to one or more user devices 102.

Similar to the secured input 154′, the secured output 156′ can also be (a) the same as the original output 156, or (b) a modified version of the original output 156. In the latter case, the security engine 202 may, for example, remove portions of the original output 156 (e.g., sensitive data) such that the output complies with the relevant policy rules.

The decision-making by the output rules agent module 212a may also be complemented by outputs generated by the multimodal conversion module 212b and content screening module 212c. These modules operate analogous to modules 210b, 210c, described above, but with respect to the model output 156. In some cases, they may be the same as modules 210b, 210c.

### III. MULTIMODAL AND CONTENT SCREENING MODULES

As shown in FIG. 2C, one or both of the input and output analysis systems 210, 212 may include: (i) a multimodal conversion module 210b, 212b, and/or (ii) a content screening module 210b, 212b

Although illustrated as separate modules and submodules, one or more of the components described herein may be combined into a single module or distributed across multiple modules or submodules performing analogous functions. The described modules and submodules may be implemented using techniques known in the art and would be readily understood and implemented by a person skilled in the art.

### (i.) Multimodal Conversion Module

The multimodal conversion module 210b, 212b can include one or more of: (i) an image-to-text submodule 214a, (ii) an audio-to-text submodule 214b, and (iii) a media extraction submodule 214c.

### (a.) Image-To-Text Submodule.

Image-to-Text Submodule 214a is configured to process input or output images to extract textual content. This includes explicit textual content (e.g., captions, embedded text, overlays) and/or to detect hidden or low-contrast text. In some examples, it can also be used to summarize visual features within the images, into corresponding textual descriptions.

In some examples, the submodule 214a comprises a trained machine learning model configured to process image data and generate corresponding textual output. The model may include an optical character recognition (OCR) component for extracting text appearing within an image. It may also include using known image-to-text or vision-language models trained to identify embedded text, or to describe imaged visual features using text.

In other examples, text extraction or object-to-text conversion is implemented without machine learning, such as using deterministic or rule-based techniques. Such implementations may include using known non-learning optical character recognition (OCR) techniques. In further examples, object descriptions are generated by detecting shapes, colors, sizes, or spatial relationships using fixed image-processing rules and mapping those detected features to predefined textual labels or phrases stored in a database.

### (b.) Audio-To-Text Submodule.

Audio-to-text submodule 214b is configured to process audio data in inputs or outputs, and generate corresponding textual outputs. This can include simply transcribing speech to text, or otherwise converting non-speech audio into a corresponding textual description.

In some examples, the submodule includes a speech recognition component that converts spoken words into text using known techniques such as acoustic feature extraction, phoneme or sub word modeling, and language-based decoding. In addition, or alternatively, the submodule may analyze audio signals to detect non-speech sounds, acoustic features, or audio events using signal processing or classification techniques, and map such detections to predefined textual labels or descriptions representing the audio content.

### (c.) Media Extraction Submodule.

Media extraction module 214c is configured to receive multimedia inputs or outputs and to process such inputs to separate constituent media elements into modality-specific components. The module may identify and isolate, for example, image data, audio data, video data, and textual data contained within a combined media stream or file, and route each separated component to a corresponding submodule for downstream analysis, processing, and policy evaluation.

Media extraction module 214c may employ any suitable media separation or segmentation technique to isolate modality-specific components for downstream analysis. For instance, this includes demultiplexing a container file to separate video frames, audio tracks, and embedded text.

### (ii.) Content Screening Module

Continuing with reference to FIG. 2C, content screening module 210c, 212c can include one or more of: (i) a textual intent detection screening submodule 214d, (ii) image screening submodule 214e, and (iii) a video screening submodule 214f.

In some cases, the textual intent detection submodule 214d is only provided for the input prompt analysis system 210.

As provided herein, the output of the content screening module 210c, 212c may include one or more of: (i) a blocking output for non-compliant text, image, or video; and/or (ii) a blocking score or textual commentary indicating a severity or likelihood of non-compliance for text, image, or video. The outputs from the contenting screening module 210c, 212c may be referenced herein as “screening outputs”. In some examples, as explained below, the screening outputs are passed to the input or output agent modules 210a, 212a for further analysis.

In at least one example, the content screening module 210c, 212c is configurable to perform screening based on one or more user-configurable preferences.

### (a.) Textual Intent Detection Screening Submodule.

Textual intent detection screening submodule 214a identifies adversarial attempts to subvert system controls and induce unauthorized GenAI model behavior. For example, this can include prompt-injection attempts that seek to override system instructions (e.g., “ignore what you have been programmed to do . . . ”).

In some examples, the submodule 214d analyzes textual components of an input prompt for persistence-evasion cues, and jailbreak patterns to flag attempts to alter model behavior or exfiltrate protected information.

The submodule 214a may be implemented as a trained machine learning model (e.g., transformer-based text classifier, sequence labeling model, or contrastive encoder) trained on labeled corpora of bad faith and good faith textual data (e.g., benign prompts, known injection/jailbreak examples, etc.).

### (b.) Image Screening Submodule.

Image screening submodule 212c is configured to assess visual elements of input or output images to determine whether the depicted content is permissible. In operation, it evaluates objects, persons, scenes, activities, and visual attributes to identify disallowed or sensitive material.

In some examples, the submodule is implemented as a trained machine learning model (e.g., vision classifier or captioning network) trained on labeled image datasets covering allowed and disallowed categories. Training may combine supervised labels for safety classes with multi-task objectives for object detection and scene description to improve generalization. In other examples, the submodule uses deterministic or rule-based image processing to detect indicators (e.g., specific shapes, markings, or symbols) and map them to policy-relevant labels.

### (c.) Video Analysis Submodule.

Video analysis submodule 212e is configured to assess visual content over time in input or output video sequences to determine whether the depicted scenes are appropriate, or otherwise comply with applicable policies.

The submodule may be implemented as a trained machine learning model configured for spatiotemporal analysis of video content, the model being trained using labeled datasets representing allowed and disallowed categories and contextual safety cues. In some examples, the model captures temporal dependencies within video sequences and generates structured outputs or natural-language descriptors usable by the rules agent module for policy evaluation.

### (iii.) Operation and Integration of Modules

FIG. 2D shows the various processing streams for input and output 154, 156 processing through the various modules of analysis systems 210, 212.

As shown, in one processing stream—if the input or output 154, 156 is purely textual, it may be analyzed directly by the input or output rules agent modules 210a, 212a.

In other cases, textual input prompts or output responses are initially passed through the content screening module 210c, 212c (e.g., the textual intent detection submodule 214d) to perform pre-rules filtering and then forwarded to the corresponding rules agent 210a, 212a for policy application. In these cases, the screening output can provide the rules agent with an indication to block the input/output, or it may provide it with score or other textual output indicating degree of compliance with preset compliance rules.

In another processing stream, where the input or output 154, 156 include non-textual media or multimodal media, the multimodal conversion module 210b, 212b initially processes the prompt or response. The multimodal conversion module 210b, 212b may either: (i) initially extract various media components, via the media extraction submodule 214c; and/or (ii) convert certain media components into textual content (e.g., via the image-to-text submodule 214a or audio-to-text submodule 214b).

Extracted or generated textual components can then be sent, (i) directly to the rules agent 210a, 212a, or otherwise, (ii) to the content screening module 210c, 212c (e.g., the textual intent detection submodule 214d) as described previously. For extracted images or video, these can be processed by the content screening module 210c, 212c (e.g., via the image analysis submodule 214e and/or video analysis submodule 214f), before the screening output is transmitted to the rules agent 210a, 212a.

### IV. MACHINE LEARNING ENABLED SECURITY ENGINE

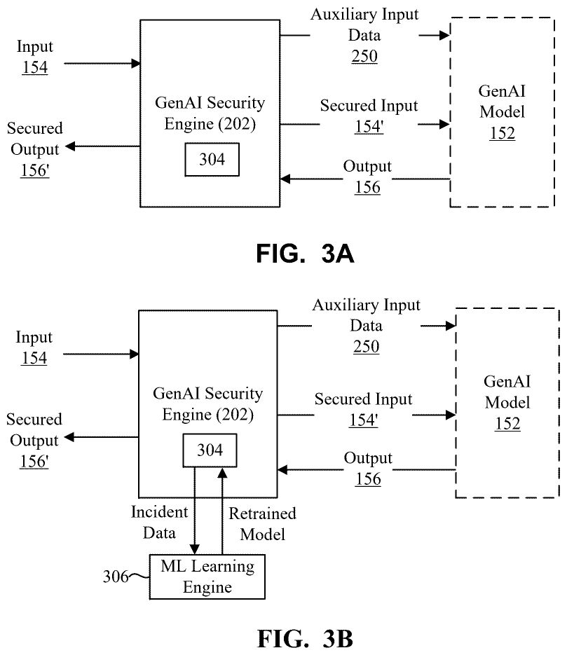

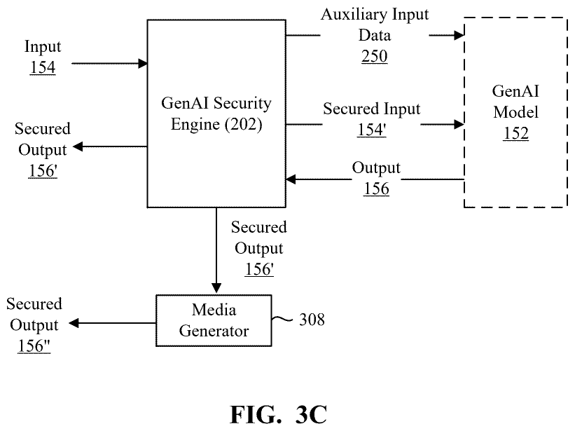

Referring to FIGS. 3A-3B, the security engine 202 may be enabled with a trained security machine learning model 304. While not explicitly illustrated, the security engine 202 in FIGS. 3A-3B can also include all of the components previously described in relation to FIG. 2A-2B.

More broadly, the trained model 302 is trained to perform one or more of the following:
(a.) Automated threat detection—The model may automatically analyze input prompts 154 to detect security threats, such as malicious scripts. In some examples, this model is trained based on previous security threats stored in the memory threat cache 208 (FIG. 2A). For automated threat detection, training data can be sourced from the memory threat cache 208 and related logs, including labeled examples of malicious prompts (e.g., exploit scripts, injection patterns), known indicators of compromise (e.g., URLs, hashes), and benign prompts for contrast. It can include annotated derivative features (e.g., flags, scores) generated during prior detections, plus contextual metadata such as user IDs, IPs, and timestamps to capture real-world attack context and sequences.
(b.) Policy compliance—As disclosed in further detail below, the model may also automatically analyze input prompts 154 or output responses 156 to, more broadly, identify presence of signatures relevant to determining compliance with security policies (e.g., automatically detecting sensitive data in input prompts). In some examples, the model is trained such to be bespoke to the specific policies of a given organization.
(c.) User profile summary generation—The model may also automatically analyze the user profile data 206 (including the audit trail) to generate a user profile summary to transmit to the GenAI model 152. In at least one example, the security engine 202 includes a single model that is trained to perform all of the above functions. In other examples, the security engine 202 includes multiple trained models, whereby each model is separately trained to perform a given function.

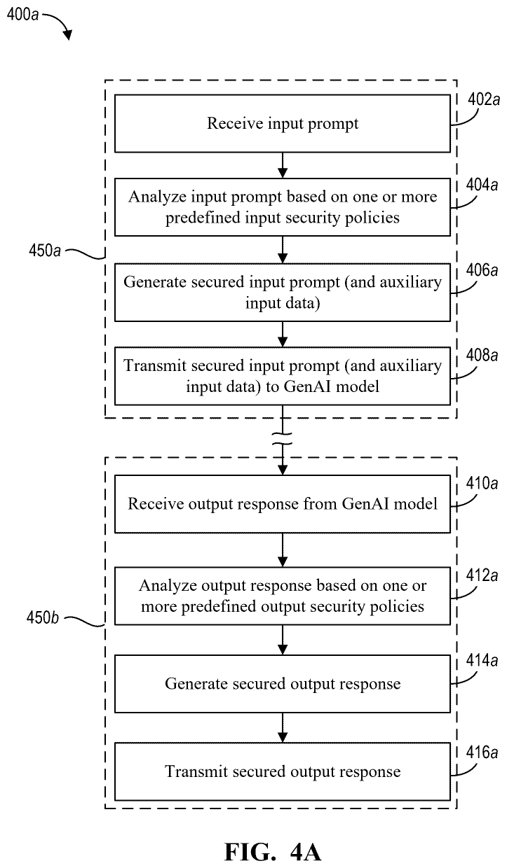

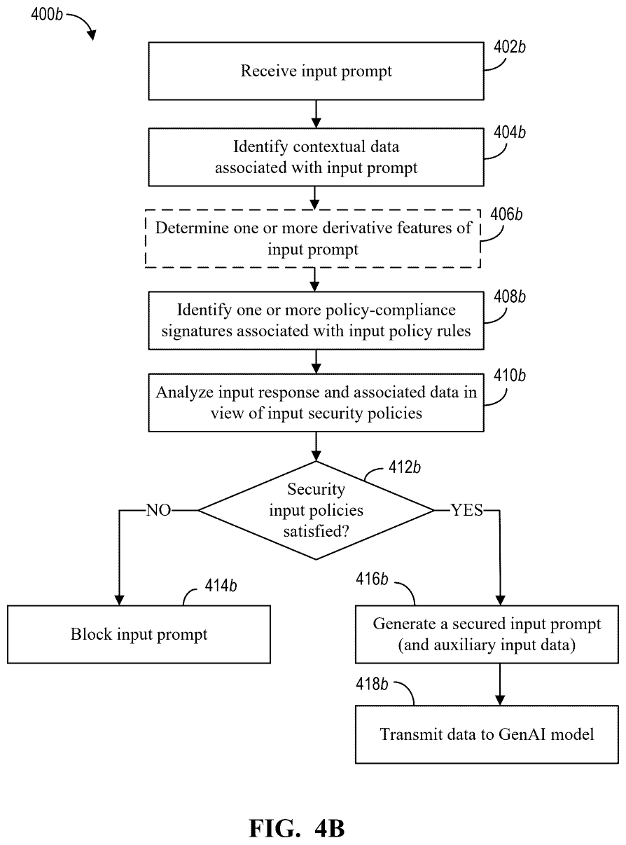

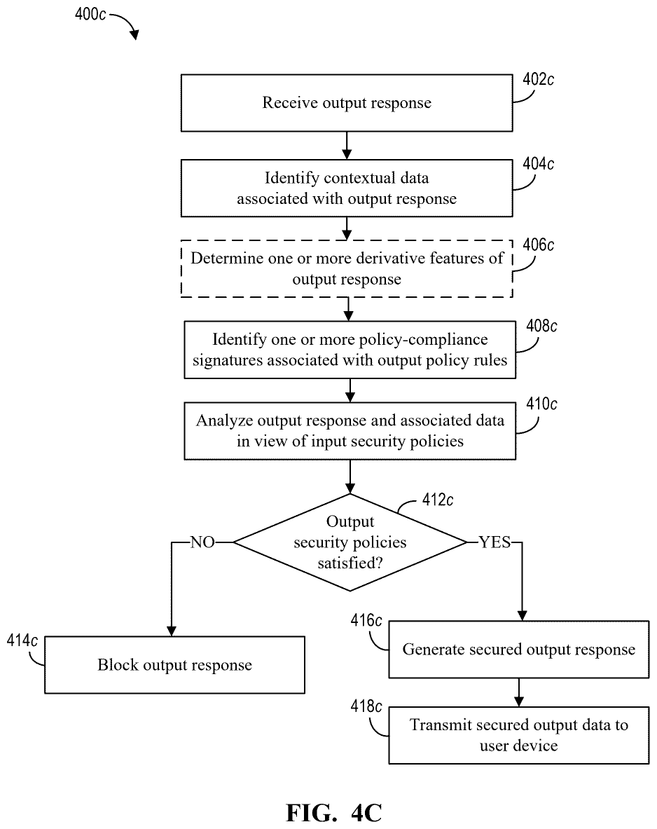

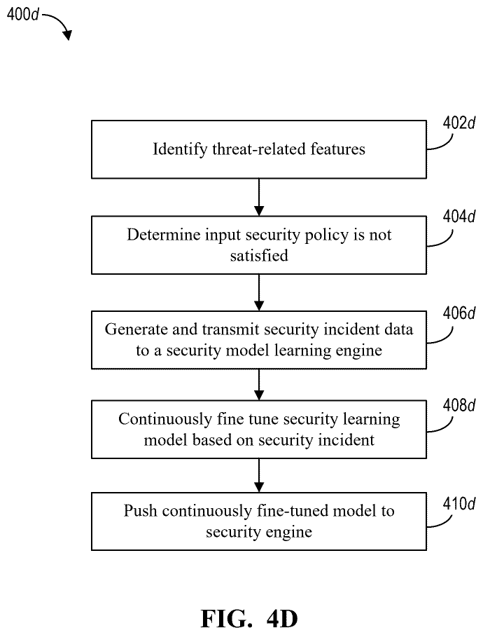

As exemplified in FIG. 3B, the security engine 202 may also be used in conjunction with an ML learning engine 306. The ML learning engine 306 can continuously fine tune the learned security model 304. For example, the ML learning engine 306 can continuously fine tune the model to detect certain classes of threats. This is explained in greater detail in the method 400d of FIG. 4D.

While the learning engine 306 and the ML learned model 304 are shown as separate entities for illustrative purposes only, they can be merged into a common implementation as needed.

### V. EXAMPLE METHOD(S)

FIGS. 4A-4D exemplify computer-implemented methods 400a-400d for operating the GenAI security engine 202. In some examples, each of the methods 400a-400d is executable by one or more processors 602 of one or more computing devices (e.g., networked computing devices). These include processors 602 of the user device 102 and/or server 104.

### (i.) General Method

FIG. 4A is a process flow for an example method 400a for using the security engine 202 in conjunction with a GenAI model 152.

Broadly, the security engine 202 is operable to perform two functions:
(i) at 450a, the security engine 202 receives an input prompt 154, and generates and transmits a corresponding secured input prompt 154′ to the GenAI model 152. In some cases, the security engine 202 also generates auxiliary input data 250; and
(ii) at 450b, the security engine 202 receives an output response 156 from the GenAI model 152, and generates and transmits a corresponding secured output response 156′ to user device(s) 102.

It is possible that the security engine 202 only performs one of acts 450a and 450b. For example, the security engine 202 may only generate secured input prompts (450a), without necessarily generating secured output responses (450b). In these cases, the output responses from the GenAI model 152 may not pass through the security engine 202.

In other examples, the security engine 202 may only generate secured output responses (450b), without generating secured input prompts (450a). In these cases, the input prompts may also not necessarily pass through the security engine 202 to the GenAI model 152.

It is also not required that acts 450a and 450b are performed by the same security engine 202. Disclosed examples contemplate using multiple or separate security engines 202 for processing input prompts and/or output responses.

In more detail, with respect to act 450a—at 402a, the security engine 202a initially receives an input prompt 154 from a user device 102. For example, a user of a user device 102 can insert an input prompt into a graphical user interface (GUI) associated with the GenAI model application. The input prompt can include an information request expressed as text, audio, image and/or video.

In some examples, the input prompt 154 may be automatically generated by the system, rather than being received from a user device 102.

At 404a, the input prompt 154 is routed to the security engine 202, which analyzes the input prompt 154 in view of one or more predefined security input policies 204a.

At 406a, in response to receiving the input prompt 154, the security engine 202 generates a corresponding secured input prompt 154′. This can be identical to the original input prompt, or a modified version thereof. In the latter case, the original input prompt may be modified to comply with the input security policies. In other cases, the security engine 202 entirely blocks the input prompt, e.g., if it fails one or more input security policies.

In some examples, at 406a, that the security engine 202 generates auxiliary input data 250. This is explained in greater detail below.

At 408a, the secured input prompt (and auxiliary input data) is transmitted and input into the GenAI model 152.

At a subsequent time, at 410a, the security engine 202 receives the output response 156 from the GenAI model 152.

At 412a, the security engine 202 then analyzes the output response 156 in view of one or more predefined security output policies 204b.

At 414a, the security engine 202 generates a corresponding secured output response 156′. This can be identical to the original output response 156, or a modified version thereof (e.g., modified to comply with the output security policies).

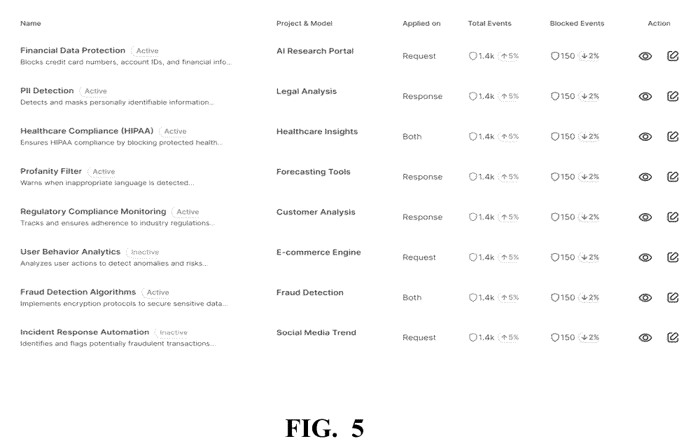

At 416a, the secured output response 156′ is transmitted to one or more user devices 102, and is output thereon. For example, it can be output through an output interface 606 (FIG. 5) of the user device 102, such as on a display or through an audio speaker.

To that end, the user device 102 transmitting the input prompt (402a) may be the same or different than the user device(s) 102 receiving the output response.

### (ii.) Method for Generating Secured Input Prompts by Security Engine

FIG. 4B is a process flow for an example method 400b for operating a GenAI security engine 202 to generate secured input prompts 154′. Method 400b expands on act 450a, in method 400a (FIG. 4A). In some examples, method 400b may be performed by operating or executing the input prompt analysis system 210 (FIG. 2B).

At 402b, the security engine 202 receives a user input prompt 154 (i.e., similar to act 402a). The input prompt 154 can be in any media form, including text, audio, image, and/or video.

At 404b, the security engine 202 can identify associated contextual data. Contextual data includes any data associated with (i) the user device transmitting the input prompt, or (ii) the actual user submitting the input prompt. As provided below, contextual data is used by the security engine 202 to determine compliance with input security policies 204a.

By way of non-limiting examples, contextual data can include: (i) the internet protocol (IP) address associated with the input user device 102, (ii) sessional login information of the user accessing the GenAI model 152, and/or (ii) any other user identifiers, of the user submitting the input prompt. In an organizational setting, user identifiers may also include the username, title, job role, employee ID, and/or predefined user access roles or privileges.

It is possible that certain contextual data is derived by analyzing other contextual data. For instance, the security engine 202 may analyze the accessing IP address, or other login credentials, to determine the geographic location of the user. The user's geographic location may also constitute contextual data, determined at 404b.

In some examples, the security engine 202 may track the number of requests transmitted from the same IP address. This tracking data can also form part of the contextual data, which can assist the security engine 202 in adaptive rate limiting, e.g., to prevent denial of service (DoS) attacks.

In some examples, at 404b, the security engine 202 retrieves contextual user-specific profile data of the accessing user. As indicated previously, the user profile database 206 can store various information about the user (e.g., job role, title access privilege), that may itself form part of the contextual data. Accordingly, it is possible that acts 404b and 406b are performed concurrently.

In at least one example, based on contextual data determined at 404b, the security engine 202 is able to identify the accessing user. This, in turn, allows the engine 202 to identify the user profile in the user profile database 206 (FIG. 2), to access further relevant contextual data. For instance, based on sessional login information or IP address, the system can identify the specific accessing user. The system may then retrieve relevant user profile data, associated with that user. It is also possible that the security engine 202 tags the input prompt with the user identifying data.

At 406b, in some examples, the system determines derivative features associated with the input prompt 154. “Derivative features” are secondary, machine-generated attributes produced by preprocessing or screening the input prompt 154 by the multimodal conversion module 210b and/or the content screening module 210c. Derivative features can be generated through the data flow previously described in FIG. 2D, and include any final or intermediate outputs generated though that data flow.

At 408b, the system identifies the various applicable input policy security rules stored in database 204a, and the associated policy non-compliance signatures associated with each rule. To provide a few examples:
An input security policy rule may require that personal information, or sensitive organizational data, is blocked from passing to the GenAI model 152. The rule may be associated with one or more policy non-compliance signatures defining types of personal information that violate the rule, including names, home addresses, or birthdates.
An input security policy rule may require that the GenAI model 152 is protected from predefined classes of security threats. The associated policy non-compliance signatures can indicate, for example, signatures of that threat (e.g., predefined queries or scripts indicative of an injection attack).
An input security policy rule may require that certain classes of information requests are blocked for certain users, user types, users with certain access privileges, or users in certain geographic locations. The policy non-compliance signatures can include classes of information that violate that rule, including requests for sensitive organizational data, or requests for ethically banned content. The signatures can also indicate the blocked users, user types, etc.

At 410b, the security engine 202 analyzes one or more of: (i) input prompt (402b), (ii) the contextual data (404b), and (iii) derivative features associated with the input prompt (406b), in view of the input security policies 204a and the associated policy non-compliance signatures. This allows the security engine 202 (e.g., input rules agent 210a) to determine if the input security policies 204a are satisfied or not. By way of example:
An input security policy may block malicious threats. In applying the policy, the security engine 202 may determine, at 410b, whether one or more malicious threat features, such as scripts, defined in associated policy non-compliance signatures and identified at 408b, are present in the input prompt or in associated derivative features.
If an input security policy provides for adaptive rating limiting to prevent denial of service (DoS) attacks, the security engine 202 can use the contextual data (404b) to determine how many inputs were previously received from the same IP address or user ID over a predefined time duration. Security engine 202 can then determine, at 410b, if the frequency of requests exceeds the permissible frequency, as dictated by the associated policy non-compliance signature for that rule.
If an input security policy requires that certain prompt requests are blocked for certain classes of users, then engine 202 can: (i) use the contextual data (404b) to determine the user's class or access privilege; and (ii) use the input prompt (402b) or derivative features (406b) to determine the type of request submitted by the user. In accordance with the policy non-compliance signature for that rule, the system can determine if the user's class is allowed to make the input request.
If an input security policy requires that certain prompt requests are blocked for users in certain geographic locations, the security engine 202 can: (i) use the contextual data (404b) to determine the user's geographic location; and (ii) use the input prompt (402b) or derivative features (406b) to determine the type of requested information. In accordance with the policy non-compliance signature for that rule, the system determines if the requested information is suitable based on the user's geographic location.
If an input security policy requires that certain sensitive data should not be passed to the GenAI model 152, then at 410b, the security engine 202 can use the input prompt (402b) or derivative features (406b) to determine if the input prompt includes any of the flagged sensitive data defined in the policy non-compliance signature. Based on this, the security engine 202 determines if the policy is satisfied or not.
An input policy may specify that the content screening module 210c must not indicate that an input prompt includes blocked content, such as inappropriate images. In such cases, the security engine 202 may determine whether an output of the content screening module 210c satisfies the input policy

In some examples, act 410b is performed using the trained security model 304 (FIGS. 3A-3B). For instance, the security model 304 is trained to automatically analyze the input prompt to identify the presence of relevant policy non-compliance signatures for each policy rule. For instance, the trained security model 304 is trained to automatically to detect queries or codes associated with malicious threats.

At 412b, based on the analysis at 410b, the security engine 202 determines if the security input policies 204a are satisfied. If this is not the case, then the input prompt is blocked at 414b. Otherwise, the input (or a modified version of the input) is passed onto the GenAI model 152.

In some examples, the security engine 202 provides a positive determination at 412b, only if all input security policies are satisfied.

In other examples, the security engine 202 may store a prioritization level for different input security policies. Accordingly, at 412b, the system only determines if “higher” prioritization policies are satisfied. In other words, it is not necessary that the security engine 202 blocks the input if any input security policy is not satisfied, but merely only if the critical policies are not satisfied.

By way of example, the security engine 202 may completely block input prompts 154 that fail to meet critical threat security policies. Alternatively, the security engine 202 may pass input prompts 154 that disclose personal information (PI)—despite failing the policy preventing PI disclosure—insofar as the prompt is modified to exclude that personal information.

The security engine 202 is also operable to determine a “risk score” associated with each input prompt 154 (e.g., between 1 to 99). This risk score can reflect the degree to which the input prompt 154 satisfies or fails different input security policies 204a. Accordingly, at 412b, the security engine 202 determines if the risk score exceeds a predetermined threshold. If not, the input prompt is blocked at 414b.

In some examples, when determining a risk score, the security engine 202 initially generates a sub-risk score for each individual policy. The final risk score is then calculated as a weighted or unweighted average of all the sub-risk scores. The risk score may also be determined only in relation to certain “higher priority” policies, rather than all policies (e.g., only a threat-based risk score is determined based on degree of malicious intent of the input prompt).

In some cases, compliance with a given policy involves ensuring that one or more (e.g., some or all) of the associated signatures are not detected.

At 416b, if the security engine 202 permits the input prompt 154′ to pass to the GenAI model 152, then it can generate a secured input prompt 154′. As indicated previously, the secured input prompt 154′ can be identical to the original input prompt 154, if it satisfies all the input security policies.

In other cases, the secured input prompt 154′ is a modified version of the original input prompt 154. For example, the original input prompt 154 may be modified to remove personal information or sensitive data (i.e., identified at act 408b). This modification can be automatic by the security engine 202, or otherwise, the security engine 202 can request the user to manually remove this data. More generally, the system can remove portions of the input prompt that do not comply with a given policy rule, or one or more of its associated signatures.

In at least one example, at 416b, that the security engine 202 generates the auxiliary data input 250. For instance, the security engine 202 can generate a user profile summary, based on the profile data retrieved at 406b. This summary is provided to the GenAI model 152 to provide contextual information about the user, such as to generate enhanced contextual output responses, as discussed previously.

It is possible that the auxiliary input data 250 is transmitted separately from the secured input, or integrated into the secured input. In the latter case, the user summary is appended to the input prompt to generate an “elongated” input prompt 154′.

At 418b, the secured input prompt 154′—along with the auxiliary input data 250—is passed to the GenAI model 152 for further processing.

### (iii.) Method for Generating Secured Output Response by Security Engine

FIG. 4C is a process flow for an example method 400c for operating a security engine for a GenAI model 152 to generate secured output response 156′. Method 400c may be performed by operating or executing the output response analysis system 212 (FIG. 2B).

Method 400c is generally analogous to method 400b, but involves analysis of output responses 156 rather than input prompts 154. Accordingly, to the extent applicable, the discussion with respect to method 400b applies to method 400c.

At 402c, the security engine 202 receives an output response 156 from the GenAI model 152. The output response can be generated by the GenAI model 152 in response to a secured, or unsecured, input prompt 154. The response can be in any media form, including any combination of text, audio, images and/or video.

At 404c, the security engine 202 determines contextual data associated with the output response. In some cases, this contextual data is identical to the contextual data, previously determined at 404b (FIG. 4B). For example, this is case where the user device transmitting the input is identical to the user device receiving the output response.

In other examples, the contextual data is re-determined at 404c. For instance, it is possible that the user device 102, receiving the output response, is different than the user device 102 transmitting the input prompt. Accordingly, new contextual data is determined for that new user device at 404c.

In other cases, the input prompt may have bypassed the security engine 202 and was directly fed into the GenAI model 152 (or the input passed through a different security engine 202 all together). As such, the security engine 202 may not have previously determined contextual data at 404b (FIG. 4B). In these cases, the security engine 202 would determine the associated contextual data at 404c.

If the contextual data is determined, or redetermined, at 404c—this may be performed in an analogous manner as previously described at act 404b (FIG. 4B). For example, the security engine 202 can determine the user device 102 receiving the output response (or requesting the output response from the engine 202). It may then determine the associated IP address, as well as various other data associated with the user device and/or the user using the user device, e.g., geographical location, access privilege and so forth. Some or all of this data is retrievable from the user profile database 206 (e.g., user-specific data).

At 406c, to the extent applicable, one or more derivative features associated with the output response 156 are determined. As explained with respect to act 406b, this can involve outputs generated by one or more of the multimodal conversion module 212b and content screening module 212c, e.g., applying the data flow in FIG. 2D.

At 408c, similar to act 408b, the system can identify applicable output policy rules in the database 204b as well as the associated policy non-compliance signatures.

By way of example, an output security policy rule may require that certain classes of information are not disclosed to specific users, user classes, users with certain access privileges, or users in certain geographic locations (i.e., which may be defined in the associated signature).

In at least one example, the security engine 202 employs one or more trained security models 304 to automatically analyze the output prompt to identify the relevant features. At 408c, the security engine 202 analyzes one or more of: (i) output response (402c), (ii) contextual data (404c), and (iii) derivative features associated with the output response (406c), in view of the output security policies 204b and the associated policy non-compliance signatures. This allows the security engine 202 (e.g., output rules agent 212a) to determine if the output security policies are satisfied or not.

By way of example, if an output security policy rule requires that certain classes of information are only accessible to certain users, user classes, user's with certain access privileges or user's in certain geographic locations (e.g., as defined in the policy non-compliance signature)—at 408c, the security engine 202 can analyze (i) the output response (402c) and/or derivative features (406c) to determine the type of information contained in the output response, and (ii) the contextual data (404c) to determine the user, user class, access privilege and/or geographic location. Based on these two elements, the security engine 202 determines if the output response complies with the output policy.

In at least one example, the security engine 202 employs one or more trained security models 304 to automatically analyze the data to determine compliance with rules.

At 412c, the security engine 202 determines if the output response satisfies the output security policies. If not, the output response is blocked at act 414c.

Similar to act 412b, at act 412c, the security engine 202 can determine one or more of: (i) if all the policies are satisfied; or (ii) if only predefined “higher priority” policies are satisfied. Alternatively, or in addition, the security engine 202 determines a “risk score” and identifies if the risk score exceeds a predetermined threshold, as described previously.

At 416c, the security engine 202 generates a secured output response 156′, based on the original output response 156. The secured output response can be (i) identical to the original output response 156, e.g., if it otherwise satisfies all the output security policies, or (ii) a modified version of the original output response, to comply with certain policies.

With respect to the latter, the security engine 202 can modify the original output response to comply with certain output policies. For example, if the contextual data indicates that the user device 102 is located in a certain geographic region, the output response is modified to be more accurate for that region, e.g., based on the output policy for that region.

At 418c, the security engine 202 transmits the secured output response to one or more user device(s) 102.

### (iv.) Method for Continuous Training of Learned Security Model

FIG. 4D is a process flow for an example method 400d for continuous training of a learned security engine model. Method 400d may be executed in the context of the environment of FIG. 3B, which includes the machine learning engine 306.

As shown, at 402d, the learned security model 304 can analyze the input prompt to determine one or more predefined threat related features.

At 404d, based on the identified threat features and/or other contextual data (404b)—the learned model 304 determines if an input security policy is not satisfied relating to threat mitigation.

At 406d, the security engine 202 generates and transmits security incident data to the ML engine 306. The security incident data can include the contextual data, as well as the identified threat-related features. As noted previously, the identified features include malicious code snippets, malware signatures (e.g., hashes or patterns), indicator of compromise (IoCs) (e.g., URLs) and other attack vectors.

At 408d, the ML engine 306 may continuously fine tune (the trained security learning model 304 based on the new incident data. In this manner, the security learning model 304 is better able to identify threat-related features and signatures, i.e., based on the threat content or the contextual data surrounding the threat (e.g., the user ID, IP address, etc.)

At 410d, the continuously fine-tuned model is pushed back to the security engine 202 for continued deployment.

### VI. ALTERNATIVE AND/OR SPECIFIC EXAMPLES

The following discussion relates to various alternative and/or specific embodiments of above described examples.

### (i.) Reconfigurability of Security Engine

In at least one example, the security engine 202 is adaptable to different GenAI models. This allows the security engine 202 to be readapted to accommodate different models, without having to retrain each GenAI model individually with new security policies (i.e., which may be computationally intensive). Instead, the security engine 202 is simply and flexibly deployed as a fronting layer in front of which ever GenAI model is desired to be secured at a given time. The security engine 202 is then dynamically configured to reflect whichever input and/or output security policies 204a, 204b are required for that GenAI model.

### (ii.) Deployment of Security Engine With Multiple Models

In some examples, the same security engine 202 is concurrently deployable with multiple GenAI models 152 (e.g., a single orchestrator engine). For example, the security engine 202 can store different input and/or output security policies 204a, 204b in association with each model. The security engine 202 can then apply the relevant policies and route data to and from the correct GenAI model 152, for a plurality of GenAI models. The engine 202 may also potentially have different configurations for the content screening modules 210c, 212c for each GenAI model.

In these examples, the user device can indicate (e.g., based on a request, or other sessional information) which GenAI model it wishes to interact with, and the security engine 202 can operate on this basis. In other examples, based on user access privileges or general input prompt queries, the security engine 202 can route the prompt to an appropriate model that the user has access to. Accordingly, the security engine 202 can reference which models are accessible by which users, or user classes.

In some examples, contextual data is shared by a single security engine 202 across multiple associated GenAI models 152 or sessions. The security engine 202 may configure the extent of context sharing per model, per user, or per session. The security engine 202 may also enforce guardrails via the input rules agent module 210a to ensure only policy-permitted context is propagated to each GenAI model. This enables coordinated operation across heterogeneous deployments while preserving confidentiality and access controls.

In other cases, a distributed number of security engines 202 are provided, each associated with a given one or more GenAI models 152. In this manner, a plurality of GenAI models 152 are controlled through a distributed number of security engines 202.

It will be also understood that the multiple security engine 202 and/or GenAI models 152 can each be hosted and distributed on several interconnected devices, rather than only a single device.

### (iii.) Enterprise Access Group Configuration

In some embodiments, the security engine 202 is configured per access group in an enterprise environment, such that input and output security policies 204a, 204b and guardrails (via modules 210a, 212a) are applied according to group-specific permissions and roles. This enables differentiated enforcement across groups without modifying the underlying GenAI model 152.

### (iv.) Output Media Generation

FIG. 3C illustrates an example arrangement in which the secured output 156′ is processed by a media generation module 308 to produce a media secured output 156″. In operation, the media generation module 308 converts the secured output into one or more media forms (e.g., as images, audio, or video). This can be based on the original input prompt and the requested modality for the output response. The module 308 may generate media from text or other structured content using known media synthesis techniques, and may be implemented as part of, or separate from, the security engine 202.

### (v.) Real-Time or Near Real-Time Operation

In some examples, the security engine 202 operates in real time or near real time by applying policy checkpoints at ingress and egress without pausing model execution.

### (vi.) Input Versus Output Security Engine

In some examples, the security engine 202 is deployed and configurable only at the input side of a GenAI model 152, and therefore comprises the input prompt analysis system 210, including the input rules agent module 210a. It may also include, where applicable, the multimodal conversion module 210b and content screening module 210c. In this configuration, the engine analyzes incoming prompts 154 against input security policies 204a, and generates secured input prompts 154′ for transmission to the GenAI model, without performing post-generation output screening. In these examples, the databases 214 may only include the input policy database 204a, and the context databases 206, 208. Further, it may not necessarily include the output response analysis system 212 and/or output policy database 204b.

In other examples, the security engine 202 is deployed and configurable only at the output side of a GenAI model 152, and therefore comprises the output prompt analysis system 212, including the output rules agent module 212a. It may also include, where applicable, the multimodal conversion module 212b and content screening module 212c. In this configuration, the engine receives original output responses 156, applies output security policies 204b, and generates secured output responses 156′, without intercepting or modifying input prompts. In these examples, the databases 214 may only include the output policy database 204b, and the context databases 206, 208. Further, it may not necessarily include the input prompt analysis system 210 and/or input policy database 204a.

In still other examples, a single instance of the security engine 202 is configured to operate bidirectionally, enforcing policies at both ingress and egress to provide end-to-end governance.

Disclosed examples also contemplate any of such security engines 202 as either a standalone engine, and/or deployed in conjunction with one more GenAI models.

### (vii.) Rule-Specific Models

In some examples, one or more policy rules in the input and/or output security policy databases 204a, 204b is associated with, and enforced using, a trained rule-specific machine learning model.

For example, there maybe a “financial data protection model”, a “PII detection model”, a “healthcare compliance (HIPAA) model”, a “profanity filter model”, a “regulatory compliance monitoring model”, and so on (see e.g., FIG. 5).

In some cases, these rule-specific models are integrated into the input rules agent module 210a and/or the output rules agent module 212a. It is possible that same rule-specific models are reused or shared between both agent modules 210a, 212a. Multiple rule-specific models can also be combined into a single trained model.

In more detail, for a given input/output security policy rule, the associated trained model may be configured to: (i) analyze input prompt/output response, derivative features, and/or contextual data, and (ii) detect the presence of policy non-compliance signatures associated with the rule.

Each model may be trained, for example, on curated repositories comprising training data associated with rule and corresponding signatures. For example, training data may include put prompt/output response, derivative features, and/or contextual data, having: (a) positive examples of rule violations that contain signature artifacts (e.g., disallowed categories or sensitive identifiers), and (b) negative examples that do not. This, in turn, enables the model to distinguish compliant from non-compliant content with confidence.

The resulting classifiers may then learn to detect whether a prompt, response, associated derivative feature set, or contextual data, includes the relevant signatures for a given rule, and to output structured determinations (e.g., satisfied/unsatisfied, allowed/borderline/disallowed).

It is also possible that these rule-specific models are trained or pre-trained large language models (LLMs), including their own GenAIs.

In some implementations, rule enforcement may be performed without trained models using, for example, deterministic or rule-based techniques (e.g., pattern matching, whitelist/blacklist checks, or thresholding). These may apply the same policy logic to detect signatures and issue decisions without ML inference. These non-learning approaches can operate alongside or in place of trained models within modules 210a and 212a.

In some examples, as best shown in FIG. 5, the system may allow control over which security policies are active (e.g., being applied and enforced) and inactive (e.g., not applied or enforced). It may also provide a graphical user interface (GUI) that summarizes total events reviewed and blocked events, etc.

### VII. MACHINE LEARNING MODELS

The machine learning models (e.g., model 304, as well as the rule-specific models discussed above) utilized in the disclosed systems can be of various types, depending on the specific application and data requirements. For example, the model may be a supervised learning model, such as a decision tree, support vector machine, or neural network, which is trained on labeled data to predict outcomes or classify inputs. The training data may correspond to the function of the model, as described above.

Alternatively, the model may be an unsupervised learning model, such as a clustering algorithm or dimensionality reduction technique, designed to uncover patterns or relationships within unlabeled data.

Other types of machine learning models may also be used, including reinforcement learning models, which optimize actions based on reward signals, or hybrid models that combine elements of different learning paradigms. The choice of model can be adapted to the particular task to enhance accuracy, efficiency, or interpretability.

In general, the model may be trained or deployed using methods and techniques that are well known to the skilled artisan, without limitation.

It is also possible that these models are trained or pre-trained large language models (LLMs), including their own GenAIs.

### VIII. EXAMPLE HARDWARE BLOCK DIAGRAM FOR COMPUTING DEVICE

FIG. 6 exemplifies a simplified hardware block diagram for an example computing device 600. Computing device 600 can comprise either the user device 102 and/or the server 104.

As shown, the computing device 600 can include a processor 602 coupled to a memory 604, via a computer data bus 650. Processor 602 can also couple to one or more of an output interface 606, an input interface 608, a communication interface 610 and/or an input/output (I/O) interface 612.

Memory 604 can store one or more of the executable methods described herein (e.g., methods 400a-400d) or any portion thereof. The memory can also store the components 204-208 (FIG. 2), as well as the learned model 304 and/or learning engine 306.

To that end, it will be understood by those of skill in the art that references herein to a computing device 600 as carrying out a function or acting in a particular way imply that processor 602 is executing instructions (e.g., a software program) stored in memory 604 and possibly transmitting or receiving inputs and outputs via one or more interfaces.

Output interface 606 can be any interface for outputting data, in any suitable form. For example, this can include a display interface (e.g., an LCD screen) for outputting visual or graphic data. It may also include an audio interface (e.g., audio speaker) for outputting audio data. It is also possible that a haptic or other interface is provided.

Input interface 608 is any interface for receiving data inputs, and can include a keyboard, mouse or the like. In the case of a touchscreen display (e.g., a capacitive touchscreen), the input interface and output interface may be one of the same.

Communication interface 610 can comprise any interface for transmitting and/or receiving data, such as over a network 150 (e.g., an antenna).

I/O interface 612 is any interface for coupling external computing devices, or other hardware, to the computing device 600.

### IX. APPRECIATED TECHNICAL ADVANTAGES

The following is a discussion of non-limiting, appreciated technical and/or technological advantages of disclosed examples.

The disclosed security engine 202 introduces a novel and concrete application of computing elements to address challenges of governing input and output transactions with generative AI (GenAI) models.

By implementing a policy-centric firewall that operates dynamically at runtime, the system evaluates inputs and outputs prior to being provided to, or released from, the GenAI model. This establishes an automated mechanism for enforcing compliance by converting unrestricted data exchanges into policy-governed transactions.

The security engine fundamentally improves the functioning of computer systems by embedding pre- and post-inference layers that operate independently of any specific GenAI model. These layers are designed to optimize computational efficiency by intercepting, modifying and/or blocking non-compliant data flow requests before they are processed by the model, thereby reducing unnecessary computational overhead and conserving system resources.

Traditional approaches to implementing safety controls often require retraining or rebuilding GenAI models, which is computationally expensive, time-consuming, and impractical. The disclosed security engine overcomes these limitations by introducing an independent compute policy enforcement layer that operates externally to the GenAI model. This modular design allows the system to be deployed rapidly, without modifying or retraining the underlying model. By appending this policy engine to the input and/or output layers, the system delivers faster response times, reduces resource consumption, thereby enhancing the scalability and adaptability of GenAI systems.

Furthermore, the security engine is capable of fronting multiple GenAI models simultaneously, each governed by its own distinct set of policies. This capability eliminates the need for retraining individual models to accommodate new or updated rules. Instead, policies are managed and updated directly within the firewall layer, enabling quick adaptation across heterogeneous deployments.

In some examples, the disclosed security engine further improves computational efficiency of a GenAI model by appending contextual data to an input prompt. Providing relevant context with the input enables the GenAI model to generate context-specific outputs within a single inference operation, thereby reducing repeated model invocations and associated computational overhead.

In view of the foregoing, disclosed examples provide “something more” by introducing a transformative architectural innovation that fundamentally alters the data flow of information within a computing system. By embedding explicit policy checkpoints at both ingress and egress points, the system ensures deterministic denial of malicious or non-compliant transactions at the input stage, preventing unauthorized data from reaching the GenAI model. On the output side, the system applies targeted transformations to generated content, ensuring compliance with policy requirements while preserving the intended functionality of the model. These features collectively provide a technical solution that enhances the operational integrity, security, and efficiency of GenAI systems, going beyond abstract ideas and delivering tangible improvements to computer functionality.

### X. INTERPRETATION

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for operating a security engine in association with a generative artificial intelligence (GenAI) model, comprising at least one of:
operating an input prompt analysis system configured for:
analyzing an original input prompt based on at least one predefined input security policy;
generating a secured input prompt, corresponding to the original input prompt; and
transmitting the secured input prompt to the GenAI model; and
operating an output response analysis system configured for:
receiving an original output response from the GenAI model;
analyzing the original output response based on at least one predefined output security policy;
generating a secured output response, based on the original output response; and
outputting the secured output response.

2. The method of claim 1, wherein the secured input prompt comprises one or more of: (i) a blocked input prompt, (ii) the original input prompt, and (iii) a modified input prompt.

3. The method of claim 2, wherein analyzing the input prompt based on the at least one predefined input security policy, comprises:
identifying contextual data associated with the input prompt;
identifying at least one policy non-compliance signature, associated with the input security policies;
analyzing one or more of the (i) input prompt, and (ii) contextual data, to determine the presence of the at least one policy non-compliance signature; and
in response to determining the presence of the signature, generating the secured input prompt comprising the blocked input prompt or the modified input prompt,
otherwise, generating the secured input prompt as comprising the original input response.

4. The method of claim 3, wherein the input prompt is multimodal, and the method further comprises determining one or more derivative features of the input prompt using a multimodal conversion module and/or a content screening module, and further analyzing the input security policies in view of the derivative features.

5. The method of claim 3, further comprising generating a user profile summary based on contextual user-specific data, and transmitting the user profile summary as the auxiliary input data to the GenAI model.

6. The method of claim 1, wherein the output response comprises one or more of: (i) a blocked output response, (ii) the original output response, and (iii) a modified output response.

7. The method of claim 6, wherein analyzing the output response based on the at least one predefined output security policy, comprises:
identifying contextual data associated with the output response;
identifying at least one policy non-compliance signature, associated with the output security policies;
analyzing one or more of the (i) output response, and (ii) contextual data, to determine the presence of the at least one policy non-compliance signature; and
in response to determining the presence of the signature, generating the secured output prompt comprising the blocked output response or the modified output response,
otherwise, generating the secured output response as comprising the original output response.

8. The method of claim 7, wherein the output response is multimodal, and the method further comprises determining one or more derivative features of the output response using a multimodal conversion module and/or a content screening module, and further analyzing the input security policies in view of the derivative features.

9. The method of claim 1, wherein the security engine includes one or more of: (i) at least one trained rule-specific model associated with enforcing an input or output security policy, and (ii) a trained security machine learning model for identifying one or more features relating to a security threat.

10. The method of claim 1, wherein the security engine is deployed in association with one or more GenAI models, and the security policies are configurable for each GenAI model.

11. A system for operating a security engine in association with a generative artificial intelligence (GenAI) model, comprising:
at least one processor; and
at least one memory storing computer-executable instructions, which when executed by the at least one processor, configure it to perform the method comprising at least one of:
operating an input prompt analysis system configured for:
analyzing an original input prompt based on at least one predefined input security policy;
generating a secured input prompt, corresponding to the original input prompt; and
transmitting the secured input prompt to the GenAI model; and
operating an output response analysis system configured for:
receiving an original output response from the GenAI model;
analyzing the original output response based on at least one predefined output security policy;
generating a secured output response, based on the original output response; and
outputting the secured output response on a user device.

12. The system of claim 11, wherein the secured input prompt comprises one or more of: (i) a blocked input prompt, (ii) the original input prompt, and (iii) a modified input prompt.

13. The system of claim 12, wherein analyzing the input prompt based on the at least one predefined input security policy, comprises:
identifying contextual data associated with the input prompt;
identifying at least one policy non-compliance signature, associated with the input security policies;
analyzing one or more of the (i) input prompt, and (ii) contextual data, to determine the presence of the at least one policy non-compliance signature; and
in response to determining the presence of the signature, generating the secured input prompt comprising the blocked input prompt or the modified input prompt, otherwise, generating the secured input prompt as comprising the original input response.

14. The system of claim 13, wherein the input prompt is multimodal, and the executed method further comprises determining one or more derivative features of the input prompt using a multimodal conversion module and/or a content screening module, and further analyzing the input security policies in view of the derivative features.

15. The system of claim 13, further comprising generating a user profile summary based on contextual user-specific data, and transmitting the user profile summary as the auxiliary input data to the GenAI model.

16. The method of claim 11, wherein the output response comprises one or more of: (i) a blocked output response, (ii) the original output response, and (iii) a modified output response.

17. The system of claim 16, wherein analyzing the output response based on the at least one predefined output security policy, comprises:
identifying contextual data associated with the output response;
identifying at least one policy non-compliance signature, associated with the output security policies;
analyzing one or more of the (i) output response, and (ii) contextual data, to determine the presence of the at least one policy non-compliance signature; and
in response to determining the presence of the signature, generating the secured output prompt comprising the blocked output response or the modified output response,
otherwise, generating the secured output response as comprising the original output response.

18. The system of claim 17, wherein the output response is multimodal, and the executed method further comprises determining one or more derivative features of the output response using a multimodal conversion module and/or a content screening module, and analyzing the input security policies in view of the derivative features.

19. The system of claim 11, wherein the security engine includes one or more of: (i) at least one trained rule-specific model associated with an input or output security policy, and (ii) a trained security machine learning model for identifying one or more features relating to a security threat.

20. The system of claim 11, wherein the security engine is deployed in association with one or more GenAI models, and the security policies are configurable for each GenAI model.
